(19) United States
(12) Patent Application Publication
(10) Pub. No.: US 2017/0293738 A1
(43) Pub. Date: Oct. 12, 2017

(54) Cognitive Adaptation of Patient Medications Based on Individual Feedback

(71) Applicant: International Business Machines Corporation, Armonk, NY (US)

(72) Inventors: Michael Bender, Rye Brook, NY (US); Rhonda L. Childress, Austin, TX (US); David B. Kumhyr, Austin, TX (US); Michael J. Spisak, East Northport, NY (US)

(21) Appl. No.: 15/094,392

(22) Filed: Apr. 8, 2016

(51) Int. Cl. G06F 19/00; G06F 17/27

(52) U.S. Cl. CPC G06F 19/3456; G06F 19/326; G06F 19/322; G06F 19/3481; G06F 17/2705; G06F 17/277

(57) ABSTRACT

Mechanisms for implementing a personalized medication adaptation engine are provided in which a cognitive system receives a request for a medication schedule that minimizes a side effect of a medication associated with a patient. The request is processed to generate at least one candidate solution for minimizing the side effect of the medication and the at least one candidate solution is evaluated against patient information for the patient. A candidate solution is selected, from the at least one candidate solution, as a final solution to be implemented in a medication schedule based on results of the evaluation and a medication schedule for administering the medication to the patient is generated based on the final solution and output to a computing device associated with the patient for implementation of the medication schedule via the computing device.

### BACKGROUND

The present application relates generally to an improved data processing apparatus and method, and more specifically to mechanisms for performing cognitive adaptation of a patient's medications based on their individual feedback as well as various sources of medication information available via a distributed data network.

Medications affect individuals differently. The differences in medication effects for different individuals may be due to any number of different factors including co-morbidities, allergies, medication interactions, individual physiology, different individual tolerances, or any other individual susceptibility of patients to one or more ingredients in the medication. While some of these effects are identified by pharmaceutical companies during development and testing of the medications, not all such effects are always identified during such development and testing. As such, the pharmaceutical company, in releasing medication labels and other industry publications regarding a medication, for use by medical personnel and patients, will not be able to cover all possible effects on patients due to their own individual reactions to the medication. Thus, while the medication labels and publications may provide some information regarding the general side effects experienced by patients found through development and testing of the medication, this information is wanting. Patients may experience side effects not documented by the medication label or publication materials due to their own individual reactions.

For example, a patient may be prescribed a medication by a medical professional based on the published medication label information, drug dictionary or reference information, and the like. Based on this information, the medical professional does not expect any side effects or may only expect a probability of the side effects specifically identified by the medication label and drug dictionary/reference information. However, the patient, having their own individual physiology, may experience side effects that were not documented in the published medication label information or drug dictionary/reference information.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system comprising at least one processor and at least one memory, the at least one memory comprising instructions which configure the at least one processor to implement a personalized medication adaptation engine. The method comprises receiving, by a cognitive system implemented by the data processing system, a request for a medication schedule that minimizes a side effect of a medication associated with a patient. The method also comprises processing, by the cognitive system, the request to generate at least one candidate solution for minimizing the side effect of the medication. In addition, the method comprises evaluating, by the personalized medication adaptation engine implemented by the at least one processor of the data processing system, the at least one candidate solution against patient information for the patient. Furthermore, the method comprises selecting, by the cognitive system, a candidate solution, from the at least one candidate solution, as a final solution to be implemented in a medication schedule based on results of the evaluation. In addition, the method comprises generating, by the personalized medication adaptation engine, a medication schedule for administering the medication to the patient based on the final solution and outputting, by the personalized medication adaptation engine, the medication schedule to a computing device associated with the patient for implementation of the medication schedule via the computing device.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a question/answer creation (QA) system in a computer network;

FIG. 2 is a block diagram of an example data processing system in which aspects of the illustrative embodiments are implemented;

FIG. 3 illustrates a cognitive system comprising a QA system pipeline and personalized medication adaptation engine in accordance with one illustrative embodiment; and

FIG. 4 is a flowchart outlining an example operation of a personalized medication adaptation engine in association with a QA system pipeline of a cognitive system in accordance with one illustrative embodiment.

### DETAILED DESCRIPTION

The illustrative embodiments provide mechanisms for evaluating a patient's individual reaction to medication and determine a schedule of the patient's activities and medication administration so as to minimize the individual patient's potential and actually experienced side effects of the medication. The illustrative embodiments utilize information from various sources, available via one or more distributed data networks, to determine the schedule that is best suited for the particular patient. These sources may include, for example, general social networking websites (e.g., Facebook™, Twitter™, Instagram™, and the like), patient blogs, support group websites, online forums established for particular types of medical maladies, pharmaceutical company websites, governmental websites, and other sources of officially recognized medication information from established medical organizations as well as sources of anecdotal information describing side effects experienced by other patients for the same medication. The information obtained from these sources may be structured or unstructured, e.g., natural language documentation. In the case of unstructured information, the mechanisms of the illustrative embodiments may utilize natural language processing techniques for identifying key features of the unstructured information for use in processing the information as part of a cognitive operation, such as may be provided in a cognitive system, for example. The mechanisms of the illustrative embodiments may further analyze similarities between the present patient and the other patients with regard to patient characteristics, other medications being taken, diagnoses associated with the patient, side effects experienced, supplements being taken, or the like, if such information is available and utilize this information as part of the cognitive operation of the cognitive system as well.

In some illustrative embodiments, the patient may utilize a smart device, sometimes referred to as an “Internet of Things” (IoT) device, through which biological measurements of the patient may be obtained, lifestyle information may be logged, such as medications taken, food/drink consumption, activities engaged in, exercise information, etc., symptoms or side effects experienced by the patient may be detected and/or logged, and the like. Moreover, the timings, durations, severity/intensity, and other attribute of each of these other monitored patient characteristics and activities may be monitored and recorded for later use. Examples of such IoT devices include, but are not limited to, the FitBit™ available from FitBit Inc., Apple Watch™ available from Apple Inc., the Microsoft Band™ available from Microsoft Corporation, and the like. In some illustrative embodiments the IoT device may be the Agito device available from International Business Machines (IBM) Corporation of Armonk, N.Y., which provides similar functionality to the other IoT devices indicated above, but also provides significant improvements with regard to integration with personal calendars of the user to provide notifications, such as notifications of available portions of the user's schedule in which to perform movement based activities. The Agito device is described in the ip.com prior art database technical disclosure entitled “A Method, Device, and Apparatus for Predictive Analytics and Movement Tracking,” electronically published on Feb. 5, 2015.

In such illustrative embodiments, the IoT device may be used to track patient biological measurements, such as vital signs (e.g., pulse, temperature, blood pressure, etc.), when the patient consumes medicine, eats/drinks, and does specific activities, as well as what these medicines are and how much is administered, what and how much food/drink is consumed, what and how much of the specific activity is performed, and the like. Such information may also be manually entered by the patient via a user interface to the IoT device, or other computing device. The information tracked is collected and stored for processing in accordance with the present invention. This tracked information comprises medical information about the patient which comprises information directed to the medical condition of the patient, e.g., the biological measurements, medicines being taken, and the like, as well as lifestyle information which comprises information about how the patient conducts their life, e.g., on a daily basis, monthly basis, or other time frame. Such lifestyle information comprises activities performed by the patient, consumption of food/drinks, and the like, and may be provided as data structures accessible through one or more interfaces with electronic calendar(s), food logs, activity logs, etc., maintained by one or more computing devices associated with the patient. The medical information and lifestyle information may collectively be referred to herein as “collected information” whereas previously documented patient information, such as medical diagnoses, lab results, medical practitioner notes, demographic information, and the like, as may be provided in patient electronic medical records (EMRs) and other patient data structures, are referred to herein as “patient information.”

Based on the collected information, information manually entered by the patient, and, in some embodiments, information present in patient EMRs, side effects of medications taken by the patient are tracked. The tracked side effects may be cross-referenced with databases of medication information to determine medication information associated with the medication and the tracked side effects, as well as social networking website sources and other sources of patient anecdotal evidence of side effects and corresponding solutions. Based on this information, a schedule for administering the medication to the patient is generated so as to minimize side effects. The schedule may be provided to a medical practitioner for approval, such as via a computing device, IoT device, or the like, associated with the medical practitioner and through which the medical practitioner may approve or reject the schedule, or provide alternatives to a portion of or all of the schedule, e.g., changing dosage information, changing timing information for administering the medication, or the like. The illustrative embodiments, having established a schedule, may provide notifications to the patient to maintain the patient's adherence to the schedule. In addition, the patient's taking of the medication, consumption of food/drink, activities, biological measurements, experienced side effects and their severity, and the like, i.e. medical information and lifestyle information, may continue to be collected and monitored so as to dynamically adjust the schedule to determine an appropriate combination of medication timing, food/drink consumption, and performance of activities to minimize experienced side effects.

It should be appreciated that the generation of the schedule may be performed pre-emptively prior to the patient starting the medication to thereby establish a baseline medication schedule. In this way, the possibility of the patient experiencing known side effects is minimized prior to the patient taking the medication. Thereafter, the mechanisms of the illustrative embodiments may utilize the IoT device and/or patient computing device, to monitor the patient's actually experienced side effects and then modify the baseline medication schedule to adjust the baseline medication schedule based on the actual activity of the patient, the actual food/drink consumption of the patient, the actual side effects experienced by the patient, their severity, and the like. Again, with each generation of a medication schedule or modification of a medication schedule, the established medication information and social networking/anecdotal information sources are consulted to determine a best schedule of activities, food/drink consumption, and taking of medication is determined. Also, any changes to the baseline medication schedule may be presented to a medical practitioner, via an associated computing device, for approval, rejection, or modification of the changed baseline medication schedule. This allows the medical practitioner to provide the final approval of the medication schedule that is implemented with the patient such that a trained medical professional is able to utilize their medical knowledge with the assistance of the mechanisms of the present illustrative embodiments, to provide the best possible medical care to the patient with regard to the administering of medications and minimizing of side effects.

In addition to the above, the illustrative embodiments may further provide functionality for informing the provider of the medication (e.g., pharmaceutical company), governmental oversight agencies (e.g., Food and Drug Administration (FDA)), medical associations (e.g., American Medical Association (AMA)), or the like, about the side effects experienced by the patient. Additional information about the patient may also be provided, such as other medications being taken, certain non-identifying patient characteristic information, and the like, so that these organizations may update their information regarding the medication. In some cases, the patient information provided may be processed by an anonymization engine which anonymizes the data prior to providing it to the organization to thereby protect the identity of the patient. By providing such information to such organizations, medication labels, drug dictionaries/reference documents, medical practitioner instructions, and the like, may be modified to accommodate the side effects experienced by the patient. In effect, the development and testing of the medication is extended to a larger population of patients after the medication has passed the original development and testing to warrant release to patients on a large scale. Thus, the organizations are given a greater amount of information regarding the effects of the medication on various types of patients.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

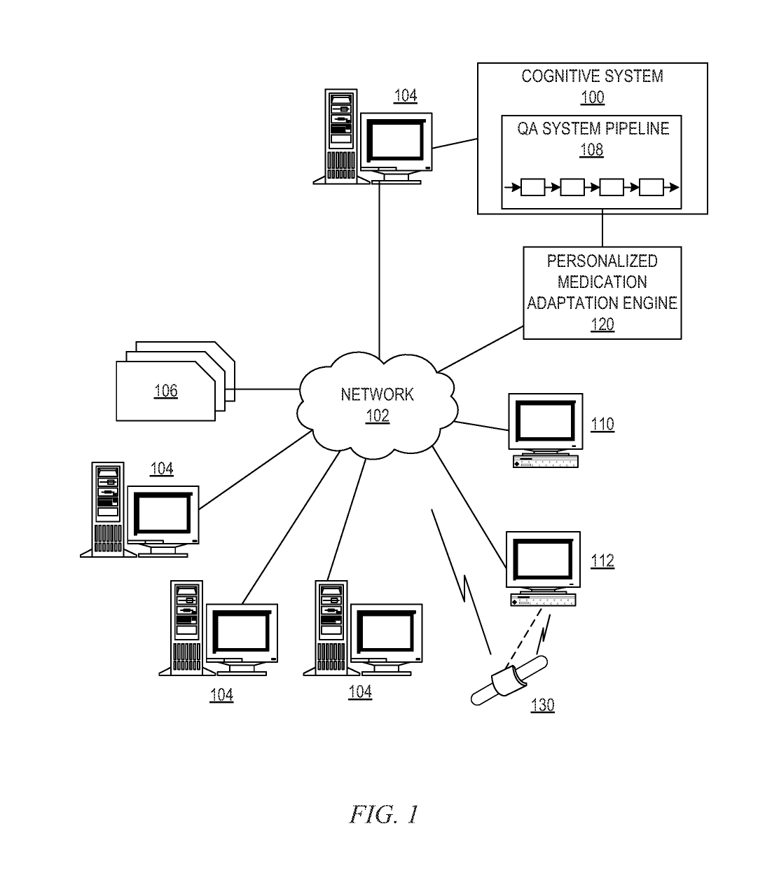

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example cognitive system implementing a Question Answering (QA) pipeline (also referred to as a Question/Answer pipeline or Question and Answer pipeline), methodology, and computer program product with which the mechanisms of the illustrative embodiments are implemented. As will be discussed in greater detail hereafter, the illustrative embodiments utilize the functionality of a cognitive system and QA pipeline to answer an implicit or explicitly provided input question or request of the nature “What is the best schedule for me [or patient A] to take my [his/her] medication?” The cognitive system operates on a corpus of information that may comprise information from a variety of different sources include, but not limited to, patient electronic medical records, medical treatment guidelines, medication label information and drug dictionaries/reference documents, social networking website information, news group or chat group information, and the like. Each source may have their own associated level of confidence in the source, e.g., patient electronic medical records may have a highest confidence, medical journals have a relatively high confidence of providing correct medication information, social networking websites directed to particular medical maladies may have a medium level of confidence, whereas social networking websites that are more generic in nature may have a relatively lower level of confidence.

In addition, the cognitive system may take as input, information received from one or more “Internet of Things” (IoT) devices, computing devices, or the like, associated with the patient and through which the patient's activity, medicine consumption, physiological condition, and the like are monitored. The cognitive system processes all of this information to determine a most appropriate schedule of activities and administering of medication so as to minimize the likelihood of the patient experiencing side effects. The side effects may be those that are specifically identified by the medication label information and drug dictionary/reference documentation as well as less common side effects experienced by patients and which are not specifically indicated in the medication label information and drug dictionary/reference documentation. For example, such less common side effects may be specified in anecdotal evidence obtained from one or more social networking websites or other sources of patient supplied side effect information.

To illustrate the operation of an example embodiment of the present invention, assume that a person, Jane Smith, takes medication A which has gastro-intestinal side effects for many patients. When prescribing medication A, the doctor recommends that the medication be taken with every meal. Now assume that Jane Smith also takes medication B which is prescribed as needing to be taken 2 hours after eating. However, there are rumors and anecdotal evidence circulated amongst social networking web sites that there are rare instances where taking medication B within 4 hours of taking medication A when exerting oneself results in migraine headaches.

In accordance with the illustrative embodiments Jane Smith maintains information about her medications in one or more IoT devices and/or computing systems that log when the medication is taken as well as others of Jane Smith's activities, biological condition measurements (such as vital signs or the like), etc. In some cases the IoT device may be a wearable IoT device, such as the FitBit™, Microsoft Band™, or the like. In other cases, the IoT device may be other types of medication oriented devices such as intelligent pill containers, an example of which is described in commonly assigned and co-pending U.S. patent application Ser. No. 14/886,786, filed Oct. 19, 2015 and entitled “Intelligent Container and Method for Medicine Dispensing Control.”

With the mechanisms of the illustrative embodiments, a baseline schedule for the patient to take their medications is generated based on the information acquired through the IoT device and through analysis of information obtained from various sources including, but not limited to, official medical sources, such as treatment guidelines, drug dictionaries and reference documents, pharmaceutical company published information, and the like. For example, the baseline medication schedule may indicate that the patient should take medication A 20 minutes after eating breakfast, when they start eating lunch, and then 15 minutes after eating dinner. In addition, the medication schedule may further specify that the person should not take medication B if they run for more than 20 minutes or more, until at least 1 hour after such strenuous exercise.

The baseline medication schedule may be presented, such as via a graphical user interface, to a medical practitioner associated with the patient, such as the patient's principle care physician, the medical practitioner that prescribed the medication, or the like, via a computing device associated with the medical practitioner. The medical practitioner is given the opportunity to review the baseline medication schedule and approve, reject, or modify this baseline medication schedule. In addition, the graphical user interface may present information indicating why any deviation from the original medication administration instructions of the original prescription were modified when generating the baseline medication schedule, e.g., while the prescription indicated that the patient should take medication A with every meal, anecdotal evidence from patient support group blogs indicates that side effects may occur and that taking the medication 20 minutes after breakfast, at lunch, and 15 minutes after dinner will minimize side effects. This provides information to the medical practitioner that he/she can review to determine whether the changes to the prescription instructions is reasonable and will not negatively affect or counteract the medical practitioner's desired treatment of the patient. The medical practitioner may then, via the graphical user interface, approve, reject, or modify the baseline medication schedule and thus, is given “final say” as to the medical treatment being provided to their patient.

The patient's adherence to this baseline medication schedule may then be monitored using their IoT device, any computer based databases that the patient updates, or the like. At some time later, the patient may enter into their IoT device, enter an indication into the computer based databases, contact their medical professional who enters information into an electronic medical record (EMR) for the patient, or the like, information indicating that the patient is experiencing a symptom which may or may not be a side effect of the medication, e.g., heart palpitations after taking medication A at lunch. In addition, or alternatively, such indications of symptoms may be automatically detected via the IoT device, a wearable health monitoring device, another health monitoring computing system or device with which the IoT device interfaces, or the like. Any mechanism by which the symptom being experienced by the patient is able to be detected may be used without departing from the spirit and scope of the illustrative embodiments.

The entry of a new symptom in association with the name of the medication may trigger a subsequent operation of the illustrative embodiments to determine if the baseline medication schedule needs to be modified to reduce any side effects of the medication. This subsequent operation may involve obtaining updated information from the patient IoT device and computer based databases or data structures, e.g., EMR, food logs, activity logs, electronic calendar, and the like. In addition, the particular medications being taken by the patient along with the specific symptom or side effect being experienced may be used as a basis for performing a search of information sources to identify any official, anecdotal, or other information available from various sources indicating potential solutions for the symptom or side effect.

Of particular interest to the present invention, social networking websites, which includes general social networking websites, patient blogs, patient support group websites, websites of associations of patients having a particular medical condition, e.g., the American Diabetes Association, or the like, may be accessed and information available from these sources may be analyzed to determine if there is anecdotal evidence of other patients experiencing the same or similar symptoms or side effects in association with the same or similar medications. Thus, for example, it may be the case that none of the official medical sources indicate the particular symptom or side effect to be experienced by patients taking medication A or medication B, but there may be anecdotal evidence from one or more of the social networking websites indicating that a portion of patients taking medication A have experienced this same or a similar side effect or symptom. Analyzing further, the illustrative embodiments may be able to determine that of those patients that experienced similar symptoms or side effects of the medication, a majority were also taking medication B, indicating a high correspondence with the present patient. The information may further be analyzed to determine if these other patients indicate a solution to the symptom or side effect and may then apply that solution to the modification of the present patient's medication schedule. For example, it may be determined that other patients experienced heart palpitations at lunch when taking medication A and that one solution is to not take medication A within 4 hours of medication B. As a result, the medication schedule may be adjusted so that administering of medication A is not done within 4 hours of medication B. Any changes to the medication schedule may again be sent to the medical practitioner associated with the patient and/or the medical practitioner that prescribed the medication, such as via a graphical user interface, electronic communication, or other notification, so that they may review, approve, reject, and/or modify the changes proposed to the medication schedule before they are implemented.

The illustrative embodiments may further interface with the patient's IoT device, a communication device (e.g., mobile phone), computing device, or the like, to update the patient's calendar or otherwise schedule reminder notifications for the patient to remind them to take their medications in accordance with the baseline and/or modified medication schedule. For example, scheduled reminders may indicate that the patient is to take their medication at 8 am, noon, and 6 pm and corresponding notifications may be output at these scheduled times in accordance with the medication schedule.

In some embodiments, the activity tracking performed through the IoT device or computing device may be continuously monitored for conditions that would indicate that the patient should or should not take their medication. For example, if the patient undergoes stressful exercise, the IoT device may detect this activity and may generate a notification that the patient should not take their medication for at least one hour after exercising. As the patient's activities may change from day to day, the timing of the administering of the medication may be dynamically determined in accordance with the patient's activity.

As noted above, some illustrative embodiments utilize a cognitive system employing one or more QA system pipelines which are augmented to include logic and functionality for providing personalized medication schedules and adapting those personalized medication schedules according to potential and actually experienced symptoms or side effects of the administered medications. While the illustrative embodiments will be described with regard to implementations in which a cognitive system is provided that includes a QA system with one or more QA system pipelines, the illustrative embodiments are not limited to such. Rather, any cognitive system having configured logic for analyzing potential side effects of medication for a particular patient and devising a baseline schedule for the administering of the medication, evaluating a patient's reaction to medication, and determining modifications for administering the medication based on the evaluation of the patient's reaction to medication and other lifestyle information about the patient, may be used without departing from the spirit and scope of the illustrative embodiments. Such a cognitive system is specifically configured and modified to implement the mechanisms of the illustrative embodiments to thereby improve the operation of the cognitive system and provide additional functionality not previously present in the cognitive system.

Since the mechanisms, in some illustrative embodiments, utilize a cognitive system including a QA system having one or more QA pipelines, it is important to first have an understanding of how question and answer creation in a cognitive system implementing a QA pipeline is implemented before describing how the mechanisms of the illustrative embodiments are integrated in and augment such QA mechanisms. The QA pipeline will be described in terms of generic questions answerable by the QA pipeline, however these mechanisms may be modified in accordance with the illustrative embodiments to be applicable to requests to evaluate potential or actual side effects of medication with regard to a particular patient. As such, references to input questions to the QA pipeline may in fact be such requests for processing of patient information to determine potential or actual side effects of medication and determining a schedule, or modification to a baseline schedule, for administering medications to the patient and performance of other lifestyle activities.

It should be appreciated that the QA mechanisms described in FIGS. 1-3 are only examples and are not intended to state or imply any limitation with regard to the type of QA mechanisms with which the illustrative embodiments are implemented. Many modifications to the example cognitive system shown in FIGS. 1-3 may be implemented in various embodiments of the present invention without departing from the spirit and scope of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

IBM Watson™ is an example of one such cognitive system which can process human readable language and identify inferences between text passages with human-like high accuracy at speeds far faster than human beings and on a larger scale. In general, such cognitive systems are able to perform the following functions:
Navigate the complexities of human language and understanding
Ingest and process vast amounts of structured and unstructured data
Generate and evaluate hypothesis
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situational awareness that mimic human cognition based on experiences
Answer questions based on natural language and specific evidence

In one aspect, cognitive systems provide mechanisms for answering questions posed to these cognitive systems using a Question Answering pipeline (QA pipeline) or Question Answering system (QA system). The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to the cognitive system which implements the QA pipeline. The QA pipeline then answers the input questions using the content in the corpus of data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e. candidate answer, is inferred by the question. This process is repeated for each of the candidate answers until the QA pipeline identifies candidate answers that surface as being significantly stronger than others and thus, generates a final answer, or ranked set of answers, for the input question.

As mentioned above, QA pipeline and mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA pipeline to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA pipeline. Content creators, automated tools, or the like, annotate or otherwise generate metadata for providing information useable by the QA pipeline to identify these question and answer attributes of the content.

Operating on such content, the QA pipeline generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

In order to provide a context for the description of the specific elements and functionality of the illustrative embodiments with regard to the integration or association of a toxicity scoring mechanism in a QA system, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a schematic diagram of one illustrative embodiment of a cognitive system 100, which implements a question/answer generation mechanism, e.g., a QA system comprising one or more QA system pipelines, in a computer network 102. One example of a question/answer generation mechanism which may be used in conjunction with the principles described herein is described in U.S. Patent Application Publication No. 2011/0125734. The cognitive system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The cognitive system 100 and network 102 enables question/answer (QA) generation functionality for one or more cognitive system users via their respective computing devices 110-112. Other embodiments of the cognitive system 100 may be used with components, systems, sub-systems, and/or devices other than those that are depicted herein.

The cognitive system 100 is configured to implement a QA system pipeline 108 that receive inputs from various sources. For example, the cognitive system 100 receives input from the network 102, a corpus of electronic documents 106, cognitive system users, and/or other data and other possible sources of input. In one embodiment, some or all of the inputs to the cognitive system 100 are routed through the network 102. The various computing devices 104 on the network 102 include access points for content creators and cognitive system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In some cases, the content creator creates content in a document of the corpus of data 106 specifically for use as part of a corpus of data with the cognitive system 100. In other cases, the documents upon which the cognitive system 100 operates are documents generated for other purposes but which are able to be processed either in a structured or unstructured manner by the mechanisms of the illustrative embodiments so as to extract knowledge from the documents that can be used to answer input questions or respond to requests. The “documents” may include any data file, text file, article, website, other type of data structure, or source of data which may be used in the cognitive system 100. Cognitive system users access the cognitive system 100 via a network connection or an Internet connection to the network 102, and input questions to the cognitive system 100 that are answered by the content in the corpus of data 106. In one embodiment, the questions are formed using natural language. The cognitive system 100 parses and interprets the question, and provides a response to the QA system user, e.g., QA system user 110, containing one or more answers to the question. In some embodiments, the cognitive system 100 provides a response to users in a ranked list of candidate answers while in other illustrative embodiments, the cognitive system 100 provides a single final answer or a combination of a final answer and ranked listing of other candidate answers.

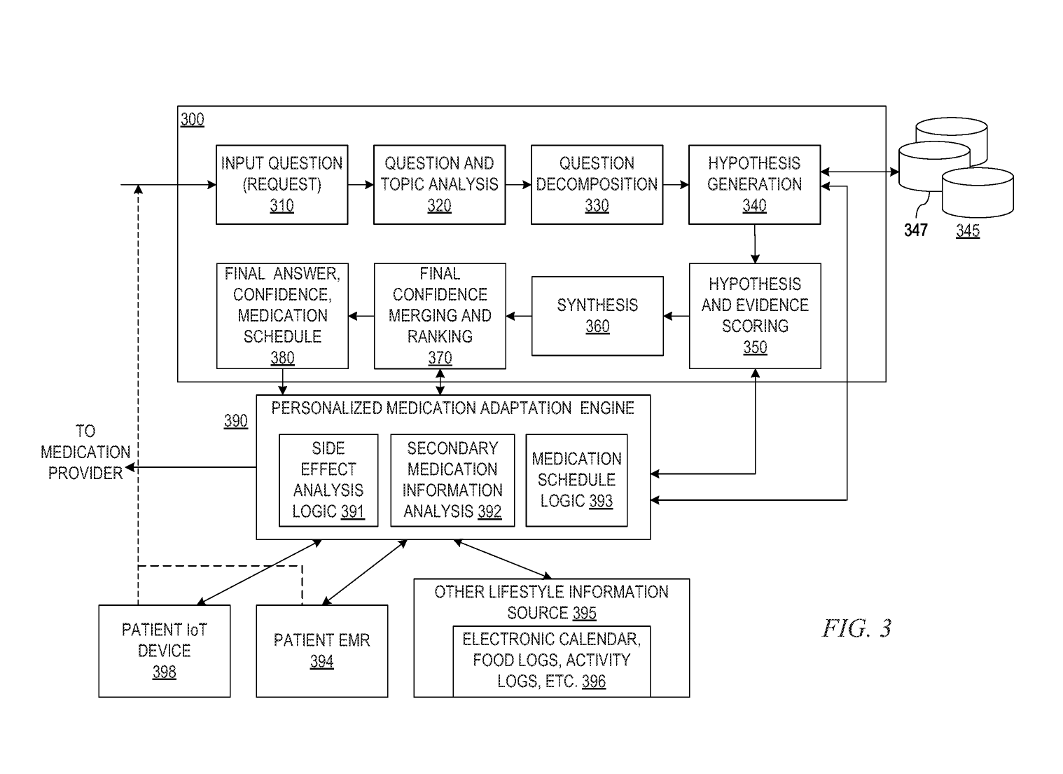

The cognitive system 100 implements a QA system pipeline 108 which comprises a plurality of stages for processing an input question and the corpus of data 106. The QA system pipeline 108 generates answers for the input question based on the processing of the input question and the corpus of data 106. The QA system pipeline 108 will be described in greater detail hereafter with regard to FIG. 3.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, the IBM Watson™ cognitive system receives an input question which it then parses to extract the major features of the question, which in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The IBM Watson™ cognitive system then performs deep analysis on the language of the input question and the language used in each of the portions of the corpus of data found during the application of the queries using a variety of reasoning algorithms. The scores obtained from the various reasoning algorithms are then weighted against a statistical model that summarizes a level of confidence that the IBM Watson™ cognitive system has regarding the evidence that the potential response, i.e. candidate answer, is inferred by the question. This process is repeated for each of the candidate answers to generate a ranked listing of candidate answers which may then be presented to the user that submitted the input question, or from which a final answer is selected and presented to the user. More information about the IBM Watson™ cognitive system may be obtained, for example, from the IBM Corporation website, IBM Redbooks, and the like. For example, information about the IBM Watson™ cognitive system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

With particular relevance to the mechanisms of the illustrative embodiments, the cognitive system 100 in FIG. 1 may be configured, through specific software/hardware configuration in accordance with the illustrative embodiments, machine learning based training of such software/hardware configurations, and the like, to utilize the QA system pipeline 108 functionality to facilitate the evaluation of medication side effects in relation to patient activities to determine optimum schedules for administering medications to the patient such that side effects are minimized. In doing so, the cognitive system 100 may be associated with, or have integrated therein, a personalized medication adaptation engine 120 that performs operations for analyzing patient information, information obtained from a patient associated IoT device 130, information obtained from a corpus of documentation, such as may be provided by sources 104, 106, 110, and the like, including official medical documentation as well as social networking and patient generated information from various websites and other sources, and the like, to thereby generate a baseline medication schedule for a patient and thereafter generate modifications to the baseline medication schedule based on actually experienced symptoms or side effects. The personalized medication adaptation engine 120 may utilize the mechanisms of the cognitive system 100 and its QA system pipeline(s) 108, to perform processing of the information in a structure or unstructured (e.g., natural language) manner to extract information regarding medications, their side effects, solutions for minimizing side effects, and the like. This information may then be utilized by the personalized medication adaptation engine 120 to apply that information to the personal schedule of the patient so as to adapt the patient's schedule to minimize the probability that the patient will experience these side effects. This may be done prior to the patient beginning treatment with a particular medication so as to generate a baseline medication schedule, and may also be done in a dynamic manner as symptoms or side effects manifest so as to modify the baseline medication schedule to minimize actually experienced symptoms or side effects. The resulting baseline medication schedule and/or modified medication schedule may be stored in association with the patient's other patient information and/or transmitted to the patient's IoT device 130 for use in establishing notifications to be output to the patient to assist the patient in adhering to the currently applicable medication schedule. As noted above, if desired in the particular implementation of an illustrative embodiment, medical practitioner(s) associated with the patient and/or that prescribed the medication, may be presented with the medication schedule prior to it being implemented so that they may be given an opportunity to approve, reject, or provide their own modifications to the medication schedule to ensure that the medication schedule meets with the medical professional's own goals for treating the patient and will not adversely affect the patient based on the medical professional's own medical knowledge.

Thus, in the context of the present invention, the “QA” system pipeline is invoked to respond to a “question” that is in actuality a request to obtain side effect information for a particular medication given a particular patient's characteristics. The request may be submitted to the cognitive system 100 and/or QA system pipeline as a result of various events. In some cases, the request may be specifically submitted by way of a user entering or selecting an option via a graphical user interface, e.g., the user entering a request by specifying in an appropriate user interface, the medications that the user is taking and the symptoms or side effects the user is experiencing. In other cases, the request may be automatically generated by a patient's IoT device 130, the personalized medication adaption engine 120, an electronic medical records (EMR) based system, such as a patient registry or the like, automatically detecting, or receiving an input from the user, indicating symptoms or side effects that the patient is experiencing and using stored information as well to populate the request, e.g., known medications that the patient is taking, current medication schedule, or the like.

When generating baseline medication schedule, this request is more generically directed to any symptoms or side effects that may be experienced by patients in general. For example, the request may be of the type “what are the potential symptoms or side effects associated with medication A for a patient having the following attributes and taking the following other medications and how do you minimize them . . . .” The request may be paired with information about the patient, as may be obtained from a patient EMR, information stored in an IoT device 130 associated with the patient, or otherwise provided by the patient via a user interface when submitting the request. When generating this baseline medication schedule, only certain types of sources of information may be utilized in the corpus, e.g., documentation from various sources 104, 106, 110, and/or 112. For example, only officially recognized treatment guidelines, medication reference documents, pharmaceutical company medication release information, e.g., medication label information, etc., and the like, from officially recognized medical organization sources may be utilized when generating an answer to the request.

When generating a modified medication schedule, the request may be more targeted and specific to the particular combination of medications and the actually experienced symptoms/side effects for the particular patient. In such a case, the request may be directed to finding ways to avoid, lessen, or otherwise minimize the occurrence of such symptoms/side effects. For example, the request may specify “how do I minimize the occurrence of side effect X when taking medication A and taking the following other medications and performing the following activities . . . .” In such a case, the other medications, activities, and the like, may be retrieved from a currently applicable medication schedule, information stored in patient EMRs, data stored in a patient associated IoT device 130, or otherwise input by the patient when submitting the request for a modified medication schedule.

The cognitive system 100 receives the request and forwards it to the QA system pipeline 108 as an input question to be processed against the corpus of information. The QA system pipeline 108 may process the request using natural language processing, to extract features of the request that are utilized to determine what answer should be provided. In extracting these features, the QA system pipeline 108 may determine whether or not the request is for a baseline medication schedule, or a modification of an existing medication schedule. If the request is for a baseline medication schedule, the QA system pipeline 108 may utilize a first sub-portion of the corpus of information to generate an answer that is then provided to the personalized medication adaptation engine 120 to generate a baseline medication schedule. If the request is for a modified medication schedule, the QA system pipeline 108 may utilize the entire corpus of information or a second sub-portion of the corpus of information, to generate the answer to the request which is again forwarded to the personalized medication adaptation engine 120 to generate a modified medication schedule. For example, the first sub-portion of the corpus may comprise only those sources that have been deemed, and are identified through configuration information used to configure the QA system pipeline 108, to be official sources of medication information that have a high confidence rating associated with them and thus, are trusted sources of information regarding medications, their symptoms and side effects, their interactions with other medications, and the like. The sources of information present in the first sub-portion may be referred to as “primary” sources of information regarding medications, their side effects and symptoms, and their interactions with other medications.

The second sub-portion of the corpus of information may comprises sources that are less trusted and may have various levels of trust depending on the source. The sources present in this second sub-portion may be referred to as “secondary” sources of information regarding medications, their side effects or symptoms, and their interactions with other medications. This second sub-portion may comprise sources of anecdotal evidence gathered from patients taking various medications and indicating symptoms/side effects experienced by the patients as well as potential solutions for minimizing such symptoms/side effects, for example. Examples of such sources include patient support group websites, medication websites, patient blogs, social networking websites, and the like, as previously mentioned above. Each of these sources may have associated confidence ratings based on the type and/or specific ones of these sources. For example, a first confidence rating may be associated with a source that has a type of “patient support group” which is a relatively higher confidence rating than a source of another type of “blog” or “general social network”. In some cases individual sources may be given their own confidence ratings based on a determined level of confidence that an administrator or other knowledgeable persons have of the source, e.g., the particular source “American Diabetes Foundation” website may be given a relatively higher confidence rating than other sources of groups of patients because over time it is determined that the information present on the American Diabetes Foundation website is more reliable than other similar sources. Any mechanism for associating confidence ratings with secondary sources may be used without departing from the spirit and scope of the illustrative embodiments.

In processing information from these sources of information, whether primary or secondary sources, the corresponding confidence ratings associated with the sources may be used by the QA system pipeline 108 to weight the evidence and answers generated from these sources. Thus, more trusted sources of information will have relatively higher weightings than other sources. This is true whether preparing the baseline medication schedule or the modified medication schedules. In embodiments where only sub-portions of the corpus of information are utilized, the relative trust evaluations based on confidence ratings will be with regard to other sources within the same sub-portion. Thus, for the baseline medication schedule creation, trusted primary sources will have their confidence ratings evaluated against each other. For the modified medication schedule creation, secondary sources will have their confidence ratings evaluated against each other.

The QA system pipeline 108 processes the input request (or question) in a manner as will be described hereafter with regard to FIG. 3, and generates a ranked listing of answers indicating potential symptoms or side effects of the medication in question, taking into account any information about the patient and other medications and activities that the patient is taking or is engaged in. The ranked listing of answers preferably pairs symptoms or side effects with corresponding solutions or recommendations for minimizing such symptoms or side effects, e.g., itchy rash—take medication A 1 hour after eating and 3 hours prior to taking medication B. Such an answer may come from a source where a statement is provided that indicates “I got an itchy rash when taking medication A but when I waited to take medication A until an hour after eating, it did not seem to be as bad.” This statement may be used in conjunction with another statement from the same or a different source that indicates “I seem to do better if I don't take medication A within 3 hours of taking medication B” or a treatment guideline that states “To avoid interactions of medication A and medication B, do not take the medications within 3 hours of one another.”

The answers generated by the QA system pipeline 108 may be provided to the personalized medication adaptation engine 120 for use in generating a baseline medication schedule or modified medication schedule for the patient. It should be appreciated that the personalized medication adaptation engine 120 may further interface, via network 102, with one or more patient EMR sources, such a server 104 that may host a patient registry having patient EMRs, to obtain personalized patient information for the patient including demographic information, prior medical history information, medication listings indicating current medications the patient is taking, and any other pertinent personal and medical information for the patient that the personalized medication adaptation engine 120 may utilized to prepare a baseline or modified medication schedule for the patient.

In addition, the personalized medication adaptation engine 120 may interface with a client machine 112 and/or an IoT device 130 (either directly or indirectly through a client machine 112), via the network 102 to obtain information about the patient, the patient's current medication schedule, electronic calendar, food logs, activity logs, biological information (e.g., vital signs such as blood pressure, pulse, temperature, etc.), and the like. The client machine 112, and/or IoT device 130 may store such electronic calendar information and logs for use in generating notifications to the patient of scheduled events and alerts in accordance with configured software settings. For example, the IoT device 130, in accordance with the illustrative embodiments, may have logic (hardware and/or software executing on hardware) for outputting a notification to a patient when a medication schedule indicates that the patient should take their medication, eat meals, and perform various activities. This medication schedule may be in the form of an electronic calendar where such events are provided on a daily basis, for example. Thus, for example, the personalized medication adaptation engine 120, based on the answers generated by the QA system pipeline 108, may generate or modify a medication schedule such that medication A is scheduled to be taken 1 hour after breakfast and 1 hour after dinner, assuming that medication A is to be taken twice a day every 12 hours. At the scheduled times, or a predetermined time before the scheduled time (e.g., such as a specified reminder time), the IoT device 130 may output a notification, such as an audible, graphical, textual, or other type of notification message on the IoT device 130 indicating that the patient is to take medication A. This notification may include dosage information and any applicable instructions for taking the medication, e.g., “with water.”

Thus, with the mechanisms of the illustrative embodiments, natural language processing and cognitive systems are utilized to determine a schedule by which a patient is recommended to take their medication so as to reduce or minimize the likelihood that the patient will experience negative symptoms or side effects. This recommendation may be provided to a medical practitioner associated with the patient, such as the patient's primary care physician, the medical professional prescribing the medication, a pharmacist through which the medication is being obtained, or the like, via a graphical user interface, electronic communication, or other notification. The medical practitioner may then provide a response to this notification of the recommendation authorizing, rejecting, or modifying the recommended medication schedule so as to ensure that a medical practitioner agrees with the medication schedule before it is implemented. In this way, the natural language processing and cognitive systems of the illustrative embodiments act as an advisor to the medical practitioner to assist the medical practitioner in addressing symptoms being experienced by the patient.

In the case that the patient experiences symptoms or side effects, the mechanisms of the illustrative embodiments may utilize secondary sources, such as anecdotal evidence obtained from other patients using the medication, to determine solutions for minimizing such symptoms or side effects and modify the medication schedule to accommodate these solutions. In this way, symptoms or side effects and/or their solutions for minimizing them, which may not be adequately documented in official medical documentation for the medication, may be utilized to adjust a medication schedule and alleviate the patient's discomfort due to the symptoms and side effects. These mechanisms may further utilize patient information and lifestyle information, e.g., electronic calendar, food logs, activity logs, etc., about the patient to determine such medical schedules.

In addition, in generating the modified medication schedules, the personalized medication adaptation engine may further provide logic for informing a source of the medications, e.g., the pharmaceutical company that manufactures the medication, a distributor of the medication, or the like, of the experienced symptoms or side effects and the corresponding solutions identified by the cognitive system 100 and personalized medication adaptation engine 120. The notifications may be sent to a computing system associated with the source of the medications, e.g., the pharmaceutical company, to inform them of the symptom or side effect and the solution determined via analysis of the secondary sources. In some illustrative embodiments, such notifications may also be sent to any oversight organizations, such as an industry organization or governmental regulatory agency, e.g., the FDA, the AMA, or the like.

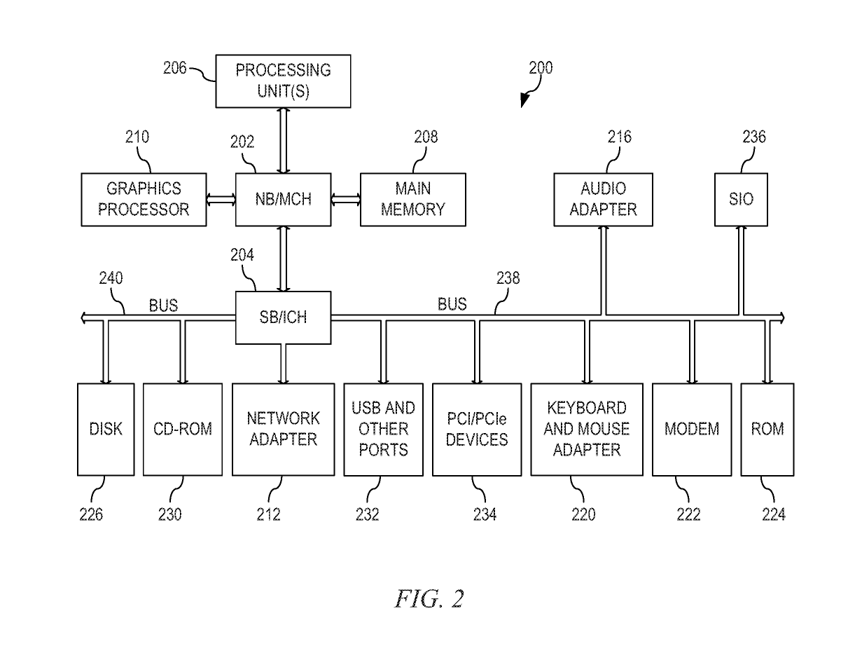

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a cognitive system 100 and QA system pipeline 108 augmented to include the additional mechanisms of the illustrative embodiments described hereafter.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 8®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates a cognitive system comprising a QA system pipeline and personalized medication adaptation engine in accordance with one illustrative embodiment. The QA system pipeline of FIG. 3 may be implemented, for example, as QA system pipeline 108 of cognitive system 100 in FIG. 1. It should be appreciated that the stages of the QA system pipeline shown in FIG. 3 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA system pipeline of FIG. 3 is augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments.

As shown in FIG. 3, the QA system pipeline 300 comprises a plurality of stages 310-380 through which the QA system operates to analyze an input question and generate a final response. In an initial question input stage 310, the QA system receives an input question that is presented in a natural language format. That is, a user inputs, via a user interface, an input question for which the user wishes to obtain an answer, e.g., “Who are Washington's closest advisors?” In response to receiving the input question, the next stage of the QA system pipeline 300, i.e. the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information 345 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 345. That is, these various sources themselves, different collections of sources, and the like, represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA system pipeline 300, in stage 350, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA system and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA system that identifies a manner by which these scores may be combined to generate a confidence score or measure for the individual hypotheses or candidate answers. This confidence score or measure summarizes the level of confidence that the QA system has about the evidence that the candidate answer is inferred by the input question, i.e. that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

The above description of FIG. 3 provides a general overview of a QA system pipeline 300 which may be used with the mechanisms of the illustrative embodiments. It should be appreciated that, in accordance with the illustrative embodiments, the QA system pipeline 300 is configured to provide recommendations for administering medications to patients so as to minimize symptoms or side effects experienced by the patients. For example, the corpus 347 or corpora 345 upon which the QA system pipeline 300 operates may be specifically configured to include documents and sources of information chosen from one or more medical domains, e.g., oncology, epidemiology, or any other medical domain. The corpus 347 or corpora 345 may comprise information from various sources includes Food and Drug Administration (FDA) databases, electronic documents representing medical texts, drug reference texts, medical journals, medical trial documentation, or any other suitable source of medical knowledge that provides information indicative of treatment plans and treatment agents as well as medications involved, their known symptoms or side effects, their known interactions with other medications, the manner by which the medications are to be administered, and the like. In accordance with a further aspect of the illustrative embodiments, the corpus 347 or corpora 345 may further include secondary sources of medication information as discussed above, e.g., patient support group websites, patient blogs, social networking websites, and the like.

Moreover, the various stages 310-380 of the QA system pipeline 300 may be configured for use in performing their operations with regard to medical terminology, medical features, and the like, of the particular domain(s) for which the QA system pipeline 300 is configured. In particular, such terminology and features may be specifically associated with medications and various symptoms, side effects, and other attributes directed to the administering of medications to patients. It should be appreciated that a QA system may comprise a plurality of such QA system pipelines 300 which may each be individually configured for different domains and may operate using differently configured corpora 345 and medication information scoring engines 390. For purposes of the following description, it will be assumed that the QA system pipeline 300 is configured for answering questions, or responding to requests, directed to the medications and their administering to patients so as to minimize side effects and symptoms. As such, the input question 310 may be of the type requesting information about symptoms and side effects of a particular medication, either alone or in combination with one or more other medications, and the associated solutions for minimizing such symptoms or side effects. For example, the input question 310 may be for a particular patient, what is the recommended medication schedule for medication A for a 40 year old female patient with high blood pressure that is also taking medication B. The input question 310 may thus, have not only the text of the question itself, but may include an identifier of the patient in the question or associated with the question, e.g., “What is the recommended medication schedule for medication A for patient 123456?” and an associated link being provided to the Jane Smith's (patient 123456) patient medical profile in the patient EMR 394 of a patient registry, from which the specific information about Jane Smith may be retrieved, e.g., 40 years old, female, previous high blood pressure diagnosis, and taking medication B.

In such a scenario, the QA system pipeline 300 may operate in much the same manner as already described above by analyzing the question and topic, decomposing the question into queries applied to the corpus 347 or corpora 345, generating hypothesis information formation, and providing an initial scoring of the hypothesis (or candidate answers) with regard to confidence and evidentiary support for the candidate answer, i.e. the operations outlined in stages 320-350 in FIG. 3. The candidate answers generated as part of the hypothesis generation 340 indicate symptoms or side effects of a specific medication or medications indicated in the input question 310 and their corresponding solutions for minimizing such symptoms or side effects. As noted above, the input question 310 may be generated manually or automatically. Manual entry may be performed in a plurality of different ways including logging on to the cognitive system and using a graphical user interface or the like to enter information for use in generating the input question 310, or using a client machine or even the IoT device 398 to enter the necessary information and upload the information to the cognitive system. Automatic entry may be done in a similar manner with the difference being that the information uploaded or provided to the cognitive system may be automatically generated based on information stored in the client device or IoT device 398.

The candidate answers indicating various possible symptoms or side effects and their corresponding solutions are provided to the personalized medication adaptation engine 390 which then scores the candidate answers according to an amount of corroborating evidence in the corpus 347 or corpora 345, confidence ratings associated with sources of such answers, and the applicability of the symptoms or side effects to the attributes of the patient, e.g., side effect Z was detected/reported by female patients over 40 and having a history of high blood pressure would match information about the current patient as retrieved as part of the patient EMR 394. To perform such scoring, the personalized medication adaptation engine 390 includes side effect analysis logic 391, secondary medication information analysis logic 392, and medication schedule logic 393, as well as additional logic within the personalized medication adaptation engine 390 to coordinate the operation of the logic 391-393 and orchestrate their operation to implement the operations for generating/modifying personalized medication schedules for patients in accordance with the illustrative embodiments.

As shown in FIG. 3, the personalized medication adaptation engine 390 receives information about the current patient from a variety of sources which include, but are not limited to, the patient IoT device 398, the patient EMR 394 corresponding to the patient as stored in a patient registry, and other lifestyle information for the patient 395, such as electronic calendars, food logs, activity logs, and the like 396. This lifestyle information may be provided by the patient IoT device 398 or another computing device, such as a patient's associated client computer, for example. The patient IoT device 398 may be a source of the most current up-to-date measured activity information and biological measurements for the patient as well as any currently applicable medication schedule being utilized with the patient. The currently applicable medication schedule may also be stored in the patient EMR 394, in a client computing device associated with the patient, in a data storage device associated with the personalized medication adaptation engine 390, or any other suitable location which can be accessed by the personalized medication adaptation engine 390 to perform its operations.

The side effect analysis logic 391 analyzes the symptom/side effect information (hereafter simply referred to as “side effect” information collectively) present in the candidate answers generated by the QA system pipeline 300, such as in stages 340 and 350, for example, and determines a level of applicability of the side effects, and their solutions for minimizing them as specified in the candidate answers, to the information specific to the patient, i.e. the patient information, patient medical information, and patient lifestyle information for the patient obtained from the patient IoT device 398, patient EMR 394, and other lifestyle information source 395. The side effect analysis logic 391 modifies the confidence scores associated with the candidate answers in accordance with their applicability to the current patient as determined from the analysis of the patient's own personal information obtained from sources 394-398. Thus, for example, if a candidate answer indicates that the side effect is a rash, but the patient does not seem to be experiencing a rash, then this candidate answer is not applicable to the current patient and the corresponding candidate answer's score is reduced. If the candidate answer indicates that the side effect is heart palpitations, and the patient is experiencing heart palpitations, as indicated by the IoT device 398, patient EMR 394, or the like, then the score for this candidate answer is increased. However, if the solution indicated in this candidate answer is to wait 3 hours after performing rigorous exercise to take medication A, but the patient's lifestyle information does not indicate that the patient engages in rigorous exercise, then the score for the candidate answer is reduced. This analysis, as can be seen, may involve a deep analysis of various information associated with the patient and may include natural language processing and other data mining and cognitive analysis mechanisms for correlating information in the IoT device provided information, patient EMR information, and lifestyle information with information in the candidate answers to determine applicability of the candidate answers' solutions to the particular patient.

Such analysis may be performed when generating a new medication schedule for a patient, such as in response to the patient being prescribed a new medication not previously administered to this patient. This new medication schedule is considered a baseline medication schedule for the new medication, but may in fact be a modified form of a previous medication schedule that involved other medications which is now modified to include the new medication and thus, represents a baseline for the new medication. The medication schedule, whether new or a modified form of a previous medication schedule, may be presented to a medical practitioner, such as the patient's primary care physician, the medical practitioner prescribing the medication, the pharmacist fulfilling the prescription, or the like, in the form of a graphical user interface, an electronic communication, or other type of notification. In the case of a graphical user interface, the notification may comprise graphical user interface elements through which the medical practitioner may approve, reject, or modify the medication schedule based on their own personal medical knowledge, their knowledge of the patient, and the like. The graphical user interface may further provide supporting evidence indicating the reasons why the medication schedule deviates from the prescribed administration instructions for the medication so that the medical practitioner can review the reasons for the deviations prior to approving, rejecting, or modifying the medication schedule. The approved or modified medical schedule is then implemented as the baseline medication schedule or modified medication schedule, thereby allowing the medical practitioner to provide final approval of the medication schedule that will be used to treat the patient.

When generating a modified medication schedule for an already prescribed medication, such as in response to a reported symptom or side effect reported manually or automatically, the personalized medication adaptation engine 390 may employ the secondary medication information analysis logic 392 to evaluate the candidate answers generated from secondary sources, e.g., anecdotal sources. The secondary medication information analysis 392 may evaluate the confidence level associated with the secondary source of the secondary medication information to thereby adjust the scoring associated with the candidate answer. For example, various weights may be associated with types of secondary sources and/or specific secondary sources with these weights being configured in the secondary medication information analysis logic 392. These weights may be provided by a system administrator or other authorized person as configuration parameters, such as a source type listing with associated weights, and/or may be learned using machine learning techniques through training and/or runtime learning operations via feedback loops or the like. Thus, for example, different weights may be associated with different types of sources such as general social networking websites, patient support group websites, patient blogs, associations corresponding to particular medical maladies, and the like. A source of a candidate answer may be correlated with a source type, or a specific identification of the source, in a data structure specifying weights for such sources, and the corresponding weight may be applied to the score of the corresponding candidate answer. The correlation with the source type may be performed by having a predefined listing of sources that match that source type, a natural language processing of text of the source with key words or key phrases associated with that source type, e.g., “blog” in a title of a web page may be used to correlate the source with the source type “blog”, or the like. A default weight may be provided for any sources that cannot be correlated with particular source types.

In some illustrative embodiments, the secondary medication information analysis 392 may be configured with logic for performing more complex analysis of the source by analyzing similarities between the present patient and the other patients that are sources of anecdotal evidence used to generate candidate answers. Such analysis of similarities may be with regard to patient characteristics, other medications being taken, diagnoses associated with the patient, side effects experienced, supplements being taken, or the like, if such information is available from the source. For example, a name of a person providing an anecdotal story via a patient support group website may be correlated with patient EMR information 394 in a patient registry and the patient's information may be compared to the current patient to determine a level of similarity. If the patient has similar attributes, then the confidence associated with this source may be relatively higher than a source whose attributes do not match the current patient.

Thus, the QA system pipeline 300 generates a listing of candidate answers based on its analysis of the input question 310 and the corpus 347 or corpora 345 upon which it operates. This analysis may involve determining whether the input question 310 is directed to generating a new baseline medication schedule or a modified medication schedule. Depending on the results of the determination, particular sub-portions of the corpora 345, or a particular corpus 347, may be utilized, e.g., a corpus 347 having only officially recognized medical information from officially recognized sources in the case of a new baseline medication schedule or a corpus 347 having secondary sources including anecdotal information in the case of a modified medication schedule. The result is a set of candidate answers that are given an initial scoring and ranking according to evidential support found in the corpus 347 or corpora 345.

Augmenting this scoring, the side effect analysis logic 391 of the personalized medication adaptation engine 390 analyzes the candidate answers to determine applicability to the patient attributes as identified from information obtained from sources 394-398. In this way, the candidate answers that are most applicable to the particular patient are scored higher than candidate answers that are less applicable, as determined by the patient's current activity and medical condition (from patient IoT device 398), any historical medical conditions, patient demographics, lifestyle information, and the like. The secondary medication information analysis logic 392 determines the relative confidence in the secondary sources of the candidate answers so as to adjust the confidence scores for the candidate answers accordingly. Thus, more highly reliable sources have the scores of their candidate answers adjusted higher than less reliable sources.

The final resulting scoring of candidate answers is used to select one or more final answers for implementation in generating a medication schedule or modifying an existing medication schedule for the medication in question. This may involve selecting the highest ranking candidate answer as the final answer for implementation, or may involve selecting candidate answers whose confidence scores meet or exceed a predetermined threshold for implementation. In the latter case, any conflicts between candidate answer may be resolved using conflict resolution logic that favors the highest ranking candidate answer.

The implementation of the final answer output by stage 380 may be facilitated by the medication schedule logic 393. The medication schedule logic 393 generates a new baseline medication schedule or a modified medication schedule based on an existing current medication schedule, such that the solutions indicated in the selected final candidate answers are used to adjust the timing of activities in the schedule for the patient. For example, if the patient's electronic calendar, as obtained from other lifestyle information source 395, indicates that the patient eats lunch at 11:30 am each day, and the solution of the selected final answer indicates that medication A should not be taken within 1 hour of eating, then a schedule for taking the medication may involve scheduling administering the medication at 1 pm each day. If the solution further states that medication A should not be taken within 3 hours of medication B, then the medication schedule may indicate that medication B should be taken at 4 pm each day. If the solution further indicates that medication A should not be taken within 2 hours of strenuous activity, then various calendar entries, such as going to the gym, running, playing flag football, and the like, may be adjusted on individual days so that their timings do no occur within 2 hours of the administering of medication A. For example, it may be determined that on Saturday, the patient has a visit to the gym scheduled for 1:30 pm which is within 2 hours of the normally scheduled time for administering medication A. As a result, either the visit to the gym or the administering of medication A may have their times adjusted to accommodate the solution, e.g., administering medication A may be moved to 10:30 am to accommodate not taking medication A within 1 hour of eating and accommodate the 1:30 pm scheduled visit to the gym such that it is not within 2 hours of taking medication A.

Each individual patient may set priorities or preferences for adjusting a medication schedule. These priorities may be based on activity types or identification of specific activities, medication types or specific medications, meal times, or the like. For example, a patient may set a priority indicating that they prefer not to move their scheduled visits to the gym and would rather adjust their medication times. As another example, a patient may indicate that they do not wish to change their medication times but are willing to change their meal times. Any combination of priorities or preferences may be set up by the patient and may be stored in configuration associated with the personalized medication adaptation engine 390, the patient IoT device 398, patient EMR 394, or other lifestyle information source 395. In the case that such configuration information is present in one of the sources 394-398, this information may be communicated to the personalized medication adaptation engine 390 along with the patient's other information used for generating a medication schedule. The medication schedule generated by the medication schedule logic 393 may be sent to a medical practitioner associated with the patient, or which is associated with the issuance of the prescription or fulfillment of the prescription of the medication, for review, approval, rejection, or modification, prior to implementation. Thus, the logic 393 may generate a notification, such as in the form of a graphical user interface that is output to a computing device, an electronic communication sent to a computing device associated with the medical practitioner, or the like. Via this notification, or as a responsive electronic communication to the notification, the medical practitioner may send a response to the logic 393 to approve, reject, or modify the medication schedule and thereby generate a final medication schedule that is implemented for the patient. The final medication schedule may then be output by the logic 393 to the patient IoT device 398 and/or patient EMR 394 for storage and implementation.

The patient IoT device 398 may implement the final medication schedule by scheduling appropriate reminder notifications to be output by the patient IoT device 398 in accordance with the scheduled events in the medication schedule. Such reminder notifications may be scheduled at times corresponding to reminder preferences set by the patient, e.g., 15 minutes before the scheduled event output an audible indicator of the scheduled event, or 5 minutes before the scheduled event output a text message and audible indicator of the scheduled event. The reminder notifications may include information regarding how to administer the particular medication in accordance with the medication information stored in the patient IoT device 398, e.g., “Take medication A—one pill with water.”

As another example, consider a situation in which a patient is an insulin dependent diabetic patient. The illustrative embodiments, through analysis of the various information available in the corpus of information regarding the administering of insulin to diabetic patients, is aware that where the insulin is administered impacts the rate of absorption. If the patient's calendar shows that the patient takes a walk after dinner, the system of the illustrative embodiments may, as part of the medication schedule, recommend the following as part of the schedule: reduce the amount of insulin by 2 units due to the 45 minute walk, administer the insulin in the patient's arm and not leg due to the extra muscular activity that would speed up the insulin absorption, and the patient should check that they are carrying quick absorbing carbohydrates to counter any low blood sugar problems. In this scenario, a first reminder may be output to the patient via their IoT device prior to a dosage of insulin at dinner so that the patient is not too late to cut back or administer the insulin shot to the wrong place. A second reminder may be output to the patient via the IoT device may indicate to the patient that they should carry extra carbohydrates prior to leaving for the walk.

Thus, the illustrative embodiments provide mechanisms for evaluating a patient's individual reaction to medication, as indicated by reported or automatically identified symptoms or side effects, and determining a schedule of the patient's activities and medication so as to minimize the individual patient's potential and actually experienced side effects of the medication. The illustrative embodiments utilize information from various sources, available via one or more distributed data networks, to determine the schedule that is best suited for the particular patient. These sources may include, for example, social networking websites and other sources of anecdotal information describing side effects experienced by other patients for the same medication. These sources may be evaluated with regard to confidence in the information provided and this confidence may be used to adjust the scoring of candidate answers generated from these sources. The mechanisms of the illustrative embodiments may analyze similarities between the present patient and the other patients (secondary sources of information) with regard to patient characteristics, other medications being taken, diagnoses associated with the patient, side effects experienced, supplements being taken, or the like, if such information is available.

In accordance with the illustrative embodiments, the patient may utilize an IoT device 398, or other smart device, through which biological measurements of the patient may be obtained, lifestyle information, such as medications taken, food/drink consumption, activities engaged in, exercise information, etc., symptoms or side effects experienced by the patient, and the like may be obtained and recorded. This information may also be provided via other lifestyle information sources as well. Moreover, the timings, durations, severity/intensity, and other attribute of each of these other monitored patient characteristics and activities may be monitored and recorded for later use by the mechanisms of the illustrative embodiments.

In such illustrative embodiments, the IoT device 398 may be used to track patient biological measurements, such as vital signs (e.g., pulse, temperature, blood pressure, etc.), when the patient consumes medicine, eats/drinks, and does specific activities, as well as what these medicines are and how much is consumed, what and how much food/drink is consumed, what and how much of the specific activity is performed, and the like. Such information may also be manually entered by the patient via a user interface to the IoT device, or other computing device, such as the other lifestyle information source 395. The information tracked is collected and stored for processing in accordance with the present invention.

Based on the collected information, information manually entered by the patient, and, in some embodiments, information present in patient EMR, side effects of medications taken by the patient are tracked. The tracked side effects may be cross-referenced with databases of medication information to determine medication information associated with the medication and the tracked side effects, as well as social networking website sources and other sources of patient anecdotal evidence of side effects and corresponding solutions, as may be provided in corpora 345. Based on this information, a schedule for administering the medication to the patient is generated so as to minimize side effects. The illustrative embodiments, having established a schedule, may provide notifications to the patient, via the IoT device 398, to maintain the patient's adherence to the schedule. In addition, the patient's taking of the medication, consumption of food/drink, activities, biological measurements, experienced side effects and their severity, and the like, may continue to be monitored so as to dynamically adjust the schedule to determine an appropriate combination of medication timing, food/drink consumption, and performance of activities to minimize experienced side effects.

In addition to the above, the illustrative embodiments may further provide functionality for informing the provider of the medication, governmental oversight agencies, medical associations, or the like, about the side effects experienced by the patient and the determined solution for such side effects. Additional information about the patient may also be provided, such as other medications being taken, certain non-identifying patient characteristic information, and the like, so that these organizations may update their information regarding the medication. In some cases, the patient information provided may be processed by an anonymization engine (not shown) which anonymizes the data prior to providing it to the organization to thereby protect the identity of the patient. By providing such information to such organizations, medication labels, drug dictionaries/reference documents, medical practitioner instructions, and the like, may be modified to accommodate the side effects experienced by the patient. In effect, the development and testing of the medication is extended to a larger population of patients after the medication has passed the original development and testing to warrant release to patients on a large scale. Thus, the organizations are given a greater amount of information regarding the effects of the medication on various types of patients.

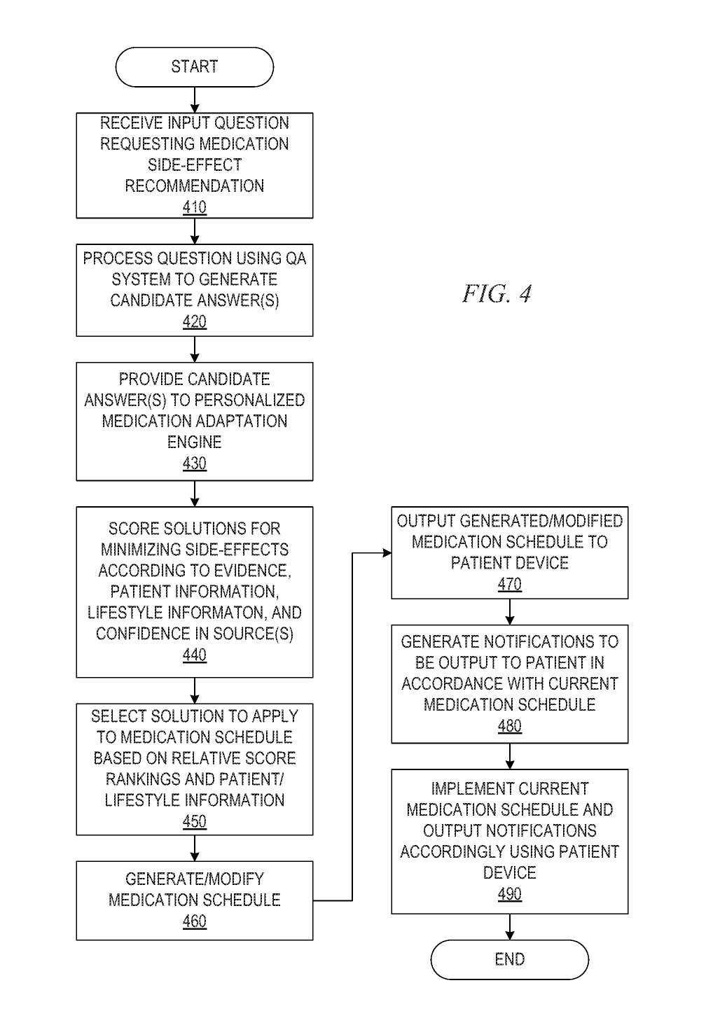

FIG. 4 is a flowchart outlining an example operation of a personalized medication adaptation engine in association with a QA system pipeline of a cognitive system in accordance with one illustrative embodiment. As shown in FIG. 4, the operation starts by receiving an input question requesting a medication side effect recommendation (step 410). As noted above, this input question, which may in fact be simply a request, may be manually entered or may be automatically generated, such as in response to the detection of a particular side effect. For example, if a patient IoT device 398 detects an increased heart rate after taking medication A, this detected event may trigger the IoT device 398 automatically generating an input question (request) to the cognitive system stating the medication, the detected side effect, a patient identifier or other patient information, and any other medications that the patient may be taking (if known to the IoT device). Alternatively, the request may be triggered, for example, in response to a doctor prescribing a new medication to the patient, or the patient EMR being updated to indicate the patient is complaining of a particular side effect, for example. This request may be received by the cognitive system as an input question requesting a recommendation for minimizing the detected side effect.

The input question (or request) is processed using the QA system to generate candidate answers (step 420). As noted above, these candidate answers map side effects to potential solutions for minimizing the side effect. The candidate answers, depending on the nature of the input question (e.g., requesting a new medication schedule or a modified medication schedule), may be from officially recognized sources of medical information or may be from secondary sources of information which include less trusted sources and sources of anecdotal information.

The candidate answers are provided to the personalized medication adaptation engine (step 430) which processes these candidate answers to modify their confidence scores and rankings in accordance with the applicability of the side effects and proposed solutions to the particular patient in question, as well as the reliability of the source (step 440). Thereafter, one or more candidate answers are selected for implementation of their corresponding solutions in a new or modified medication schedule (step 450). A medication schedule is then generated by either generating a new medication schedule or modifying an existing medication schedule (step 460). This may involve accessing personal lifestyle information for the patient including any electronic calendars, food logs, activity logs, and the like, to obtain information about scheduled activities or events that the patient is involved in and adjusting timings of administering medication and timings of such activities. Although not explicitly shown in FIG. 4, it should be appreciated that the medication schedule, whether new or modified, may be sent to a medical practitioner associated with the patient, associated with the prescribing of the medication, or otherwise associated with the fulfillment of the prescription, to obtain final approval of the medication schedule prior to its implementation, as previously discussed above.

The resulting medication schedule is output to a patient device, such as an IoT device, patient's smart device, or a client computing device associated with the patient (step 470). The medication schedule is then implemented by the patient device by generating notifications to be output to the patient in accordance with the medication schedule (step 480). The medication schedule is then implemented such that the generated notifications are output accordingly using the patient device (step 490). The operation then terminates. While the flowchart illustrates a termination of the operation, it should be appreciated that this operation may be repeated when subsequent requests or input questions are submitted to the cognitive system, in which case the current medication schedule may be considered a source for modification during the processing of the subsequent request or input question.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions which configure the at least one processor to implement a personalized medication adaptation engine, the method comprising:
receiving, by a cognitive system implemented by the data processing system, a request for a medication schedule that minimizes a side effect of a medication associated with a patient;
processing, by the cognitive system, the request to generate at least one candidate solution for minimizing the side effect of the medication;
evaluating, by the personalized medication adaptation engine implemented by the at least one processor of the data processing system, the at least one candidate solution against patient information for the patient;
selecting, by the cognitive system, a candidate solution, from the at least one candidate solution, as a final solution to be implemented in a medication schedule based on results of the evaluation;
generating, by the personalized medication adaptation engine, a medication schedule for administering the medication to the patient based on the final solution; and
outputting, by the personalized medication adaptation engine, the medication schedule to a computing device associated with the patient for implementation of the medication schedule via the computing device.

2. The method of claim 1, wherein the request is automatically generated by the computing device associated with the patient in response to one of the patient providing manual input to the computing device indicating a medical condition of the patient corresponding to the side effect, or automatic detection by the computing device associated with the patient of the medical condition of the patient corresponding to the side effect.

3. The method of claim 2, wherein the computing device automatically generates the request in response to the computing device automatically detecting biological measurements of the patient and tracking at least one of actions of taking the medication or lifestyle actions performed by the patient.

4. The method of claim 1, wherein generating, by the personalized medication adaptation engine, a medication schedule for administering the medication to the patient based on the final solution comprises modifying a previously generated medication scheduled for the patient based on the final solution.

5. The method of claim 1, further comprising:
sending, by the data processing system, a notification output to a computing system associated with at least one of a provider of the medication, a governmental oversight agency, or a medical association in response to selecting the candidate solution, wherein the notification identifies the side effect and the selected candidate solution.

6. The method of claim 1, wherein processing the request to generate at least one candidate solution for minimizing the side effect of the medication comprises searching at least one of social networking website sources, patient blog sources, patient support group website sources, or patient association website sources for anecdotal evidence of a candidate solution for inclusion in the at least one candidate solution.

7. The method of claim 1, wherein the medication schedule for administering the medication to the patient based on the selected candidate solution comprises relative timings for taking the medication and performing lifestyle activities, wherein the relative timings are established in the medication schedule to minimize the side effect.

8. The method of claim 7, further comprising:
dynamically monitoring, by the computing device associated with the patient, activity of the patient; and
dynamically modifying, by the data processing system, the medication schedule based on the dynamic monitoring of the activity of the patient.

9. The method of claim 1, further comprising:
determining, by the data processing system, whether the request is a first request to generate a baseline medication schedule for administering the medication to the patient or a second request to generate a modification to a baseline medication schedule;
in response to determining that the request is a first request, processing the request to generate at least one candidate solution for minimizing the side effect of the medication comprises performing natural language processing operations on a first portion of a corpus of information comprising only official medical guideline documentation for administering the medication; and
in response to determining that the request is a second request, processing the request to generate at least one candidate solution for minimizing the side effect of the medication comprises performing natural language processing operations on a second portion of the corpus of information comprising documentation sources of anecdotal evidence of other patients.

10. The method of claim 1, further comprising:
wherein processing the request to generate at least one candidate solution for minimizing the side effect of the medication comprises performing natural language processing of a corpus of information comprising a plurality of sources of medication information, side effect information, and potential solutions for minimizing side effects of medications, and wherein different weights are applied to information obtained from different sources according to a relative rating of trustworthiness of the different sources.

11. A computer program product comprising a computer readable storage medium having a computer readable program stored therein, wherein the computer readable program, when executed on a data processing system, configures the data processing system to implement a personalized medication adaptation engine that operates to:
receive a request for a medication schedule that minimizes a side effect of a medication associated with a patient;
process the request to generate at least one candidate solution for minimizing the side effect of the medication;
evaluate the at least one candidate solution against patient information for the patient;
select a candidate solution, from the at least one candidate solution, as a final solution to be implemented in a medication schedule based on results of the evaluation;
generate a medication schedule for administering the medication to the patient based on the final solution; and
output the medication schedule to a computing device associated with the patient for implementation of the medication schedule via the computing device.

12. The computer program product of claim 11, wherein the request is automatically generated by the computing device associated with the patient in response to one of the patient providing manual input to the computing device indicating a medical condition of the patient corresponding to the side effect, or automatic detection by the computing device associated with the patient of the medical condition of the patient corresponding to the side effect.

13. The computer program product of claim 12, wherein the computing device automatically generates the request in response to the computing device automatically detecting biological measurements of the patient and tracking at least one of actions of taking the medication or lifestyle actions performed by the patient.

14. The computer program product of claim 11, wherein the computer readable program further causes the data processing system to generate a medication schedule for administering the medication to the patient based on the final solution at least by modifying a previously generated medication scheduled for the patient based on the final solution.

15. The computer program product of claim 11, wherein the computer readable program further causes the data processing system to:
send a notification output to a computing system associated with at least one of a provider of the medication, a governmental oversight agency, or a medical association in response to selecting the candidate solution, wherein the notification identifies the side effect and the selected candidate solution.

16. The computer program product of claim 11, wherein the computer readable program further causes the data processing system to process the request to generate at least one candidate solution for minimizing the side effect of the medication at least by searching at least one of social networking website sources, patient blog sources, patient support group website sources, or patient association website sources for anecdotal evidence of a candidate solution for inclusion in the at least one candidate solution.

17. The computer program product of claim 11, wherein the medication schedule for administering the medication to the patient based on the selected candidate solution comprises relative timings for taking the medication and performing lifestyle activities, wherein the relative timings are established in the medication schedule to minimize the side effect.

18. The computer program product of claim 17, the computer readable program further causes the data processing system to:
dynamically monitor activity of the patient; and
dynamically modify the medication schedule based on the dynamic monitoring of the activity of the patient.

19. The computer program product of claim 11, wherein the computer readable program further causes the data processing system to:
determine whether the request is a first request to generate a baseline medication schedule for administering the medication to the patient or a second request to generate a modification to a baseline medication schedule;
in response to determining that the request is a first request, the computer readable program further causes the data processing system to process the request to generate at least one candidate solution for minimizing the side effect of the medication at least by performing natural language processing operations on a first portion of a corpus of information comprising only official medical guideline documentation for administering the medication; and
in response to determining that the request is a second request, the computer readable program further causes the data processing system to process the request to generate at least one candidate solution for minimizing the side effect of the medication at least by performing natural language processing operations on a second portion of the corpus of information comprising documentation sources of anecdotal evidence of other patients.

20. The computer program product of claim 11, wherein the computer readable program further causes the data processing system to process the request to generate at least one candidate solution for minimizing the side effect of the medication at least by performing natural language processing of a corpus of information comprising a plurality of sources of medication information, side effect information, and potential solutions for minimizing side effects of medications, and wherein different weights are applied to information obtained from different sources according to a relative rating of trustworthiness of the different sources.

21. An apparatus comprising:
at least one processor; and
at least one memory coupled to the processor, wherein the at least one memory comprises instructions which, when executed by the at least one processor, configures the at least one processor to implement a personalized medication adaptation engine that operates to:
receive a request for a medication schedule that minimizes a side effect of a medication associated with a patient;
process the request to generate at least one candidate solution for minimizing the side effect of the medication;
evaluate the at least one candidate solution against patient information for the patient;
select a candidate solution, from the at least one candidate solution, as a final solution to be implemented in a medication schedule based on results of the evaluation;
generate a medication schedule for administering the medication to the patient based on the final solution; and
output the medication schedule to a computing device associated with the patient for implementation of the medication schedule via the computing device.
